(19) United States
(12) Patent Application Publication
(10) Pub. No.: US 2008/0291183 A1
(43) Pub. Date: Nov. 27, 2008

(54) Display driver and image display apparatus

(75) Inventor: Fumio Koyama, Shiojiri-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/149,495

(22) Filed: May 2, 2008

(30) Foreign Application Priority Data
May 21, 2007 (JP) JP 2007-134590

(51) Int. Cl. G09G 5/00

(52) U.S. Cl. 345/204; 345/55

(57) ABSTRACT

A display driver for driving a display device having a plurality of pixels, the display driver comprises: an image processor that receives an image signal that contains information to be displayed on each of the plurality of pixels and applies a predetermined processing on the image signal to output a processed image signal; a selector that selects the information corresponding to a predetermined pixel among the plurality of pixels to output a selected image signal; and a memory that temporarily stores the selected image signal output by the selector, the selected image signal being read out from the memory to be fed to the predetermined pixel of the display device through a signal feed line.

The entire disclosure of Japanese Patent Application No. 2007-134590, filed May 21, 2007, is expressly incorporated by reference herein.

### BACKGROUND

1. Technical Field

The invention relates to a display driver for driving a display device having a plurality of pixels and an image display apparatus.

2. Related Art

Traditionally, image display apparatuses with a display device such as a liquid crystal panel having a plurality of pixels have been provided with a display driver for driving the display device (i.e. writing image onto each of pixels of the display device) by feeding image signal into the display device.

In order to improve image quality, it has been proposed to provide a frame memory on the display driver to drive the display device at a double speed to write the same image twice on the display device within one vertical scanning period (see, for instance, JP-A-2004-177930).

Various techniques for improving image quality and enlarging display size of the display device are now under development, where various display devices with different display format have been proposed. Traditionally, considering the memory capacity of the frame memory, dedicated display driver have been provided respectively for the various display devices.

For instance, a display driver dedicated for display devices for a display format corresponding to 720p (1280×720p) (referred to as 720p display driver hereinafter) employs a frame memory that stores 1280×720 screen pixel data. Further, another display driver dedicated for display devices for a display format corresponding to 1080p (1920×1080p) (referred to as full HDTV display driver hereinafter) employs a frame memory that stores 1920×1080 screen pixel data. In other words, the full HDTV display driver requires a frame memory with relatively large memory capacity.

It is possible to install a full HDTV display driver to a display device for the display format corresponding to 720p solely in terms of the capacity of the frame memory, which, however, is not practical since such an arrangement requires a display driver more expensive than the 720p display driver.

Accordingly, a technique has been desired that allows a display driver to be used in common to display devices with different display format.

### SUMMARY

An object of the invention is to provide a display driver that is capable of being used in common to display devices with different display formats, and image display apparatus.

A display driver according to an aspect of the invention is for driving a display device having a plurality of pixels, the display driver including: an image processor that receives an image signal that contains information to be displayed on each of the plurality of pixels and applies a predetermined processing on the image signal to output a processed image signal; a selector that selects the information corresponding to a predetermined pixel among the plurality of pixels to output a selected image signal; and a memory that temporarily stores the selected image signal output by the selector, the selected image signal being read out from the memory to be fed to the predetermined pixel of the display device through a signal feed line.

In the above aspect of the invention, since the display driver includes the image processor, the selector and the memory, the display driver can be used in common to display devices with different display formats as follows.

Incidentally, for the convenience of simplifying the description, a display device with a display format corresponding to 720p and a display device with a display format corresponding to full HDTV (1080p) are exemplified as the display devices.

For instance, the memory capacity of the memory constituting the display driver is set to be capable of storing 960×1080 screen pixel data, which is larger than 1280×720 screen pixel data corresponding to 720p. Then, the display driver is operated, for instance, as follows to drive a display device with a display format corresponding to 720p.

Specifically, the image processor receives an image signal containing pixel data to be displayed for each of the plurality of pixels and applies various image-processing such as edge enhancement, black-and-white extension, color conversion, gamma correction, VT-gamma correction and shape correction to the image signal to output a processed image signal.

Next, the selector selects the pixel data corresponding to all the pixels among the plurality of pixels to output the selected image signal (equal to the processed image signal).

After the selected image signal is sequentially written on the memory, the pixel data is sequentially read out at a frequency twice as high as the writing frequency of the selected image signal. The selected image signal containing the sequentially fetched pixel data is fed to the display device.

The above operation of the display driver reads out the pixel data at a frequency twice as high as the data-writing frequency to the memory to feed the pixel data to the display device (driving the display device at a double speed), which allows the same images to be written twice on the display device, thereby driving the display device adapted for display format of 720p.

On the other hand, with the use of two display drivers in parallel, which, for instance, are operated as follows to drive a display device with a display format corresponding to full HDTV.

Specifically, the image processors of the two display drivers respectively receive image signals containing pixel data to be displayed for each of the plurality of pixels and apply various image-processing as in the above to the image signals to output a processed image signal respectively.

Next, the selector of one of the display drivers selects, from the processed image signal, odd-numbered pixel data on a particular scan line among the plurality of pixels of the display device and outputs a selected image signal containing the selected respective pixel data.

Next, the other selector of the display drivers selects, from the processed image signal, even-numbered pixel data of on the particular scan line among the plurality of pixels of the display device and outputs a selected image signal containing the selected respective pixel data.

Here, since the memory capacity of the frame memories of the display drivers is set so that 960×1080 screen pixel data can be stored therein. However, since 960×1080 screen pixel data (odd-numbered and even-numbered pixel data), i.e. half of the 1920×1080 screen pixel data corresponding to full HDTV, is selected and is output as the selected image signals, the 1920×1080 screen pixel data can be stored in the respective memories. After the selected image signals are sequentially written on the memory, the pixel data is sequentially read out at, for instance, a frequency twice as high as the writing frequency of the selected image signal. The selected image signals containing the sequentially fetched pixel data are fed to the display device and the respective pixel data are written on the odd-numbered and even-numbered pixels on the particular scan line.

The above operation of the two display drivers reads out the pixel data at a frequency twice as high as the data-writing frequency to the memory to feed the pixel data to the display device (driving the display device at a double speed), which allows the same images to be written twice on the display device, thereby driving the display device adapted for display format of full HDTV.

Further, the image signal corresponding to all the pixels and containing 1920×1080 screen pixel data is input to the image processors of the two display drivers. Accordingly, when edge enhancement that requires calculation of difference between pixel data (pixel value) of adjoining pixels and black-and-white extension that requires calculation of average value of the pixel data (pixel value) of all the pixels on one screen are to be conducted, the image processors can efficiently apply the edge enhancement and black-and-white extension by the same image processing on the respective image signals. Accordingly, the same image processing can be applied on the image written on the odd-numbered pixels of the display device based on the selected image signals to which edge enhancement and white-and-black extension processing have been applied by one of the display drivers, and on the image written on the even-numbered pixels of display device based on the selected image signals to which edge enhancement and white-and-black extension processing have been applied by the other of the display device, thus exhibiting excellent display image without causing uncomfortable feeling.

Further, the memories of the display devices are provided with relatively small memory capacity (capacity that allows storing 960×1080 screen pixel data). Accordingly, even when the two display drivers are used for driving the display device of the display format corresponding to full HDTV, production cost can be reduced as compared to a conventional arrangement where a single display driver provided with a frame memory with relatively large memory capacity (capacity that allows storing 1920×1080 screen pixel data).

Incidentally, though a display device with a display format corresponding to 720p and a display device with a display format corresponding to full HDTV (1080p) are exemplified above, the display driver of the invention can be used in common to the display device with the other display format.

In the display driver according to the above aspect of the invention, the signal feed line may preferably includes a plurality of signal feed lines and the selected image signal to be fed to different pixels of the display device may preferably be read out from the memory for each of the plurality of signal feed lines.

According to the above arrangement, since a plurality (two, for instance) of signal feed lines are provided, after the selected image signal is sequentially written on the memory, the two pixel data, for instance, are sequentially read out, and the two selected image signals are respectively supplied to the display device through two signal feed lines. Accordingly, the pixel data is sequentially read out at a frequency twice as high as the writing frequency of the selected image signal, thereby suitably effecting double-speed driving of the display device.

In the display driver according to the above aspect of the invention, the selected image signal to be fed to the pixels of the display unit is preferably read out from the memory through the signal feed line at a frequency equal to an integral multiple of the selected image signal output by the selector.

According to the above arrangement, after the selected image signal is sequentially written on the memory, the pixel data can be sequentially read out at a plurality of times (e.g. twice) as high as the writing frequency of the selected image signal and the selected image signal can be fed to the display device, thereby achieving suitable double-speed driving of the display device without providing a plurality of signal feed lines.

The display driver according to an aspect of the invention preferably includes a single-phasing circuit that, when the image signal input to the display driver is extended into a plurality of phases, single-phases the image signal of the plurality of phases to output to the image processor.

According to the above arrangement, since the display driver includes the single-phasing circuit, it is not necessary to provide a plurality of image processors each corresponding to a multi-phase image signal but it is sufficient to provide a single image processor, thus simplifying the circuitry of the display driver.

An image display apparatus according to another aspect of the invention includes a display device having a plurality of pixels and the above-described display driver.

In the above image display apparatus, the display driver preferably includes a plurality of display drivers arranged in parallel to the display devices.

According to the above arrangement, since the image display apparatus includes the display device and the above-described display driver, the same advantages and effects as the above-described display driver can be obtained.

The image display apparatus according to the above aspect of the invention, the display device is preferably an optical modulator that modulates an incident light beam based on the selected image signal fed by the display driver, and the image display apparatus is preferably a projector including a light source that irradiates a light beam toward the optical modulator and a projection optical device for projecting the light beam modulated by the optical modulator.

According to the above arrangement, since the above-described image display apparatus is a projector, the above-described effect can be effectively exhibited.

### BRIEF DESCRIPTION OF THE DRAWINGS

The invention will be described with reference to the accompanying drawings, wherein like numbers reference like elements.

FIG. 1 is a block diagram showing an arrangement of a projector according to an exemplary embodiment of the invention.

FIG. 2A and FIG. 2B are block diagrams showing an outline of respective LCD drivers of the above exemplary embodiment.

FIG. 3 is an illustration for explaining an effect of the above exemplary embodiment.

FIG. 4A and FIG. 4B are block diagrams showing a modification of the above exemplary embodiment.

### DESCRIPTION OF EXEMPLARY EMBODIMENT(S)

### Overall Arrangement of Projector

An exemplary embodiment of the invention will be described below with reference to attached drawings.

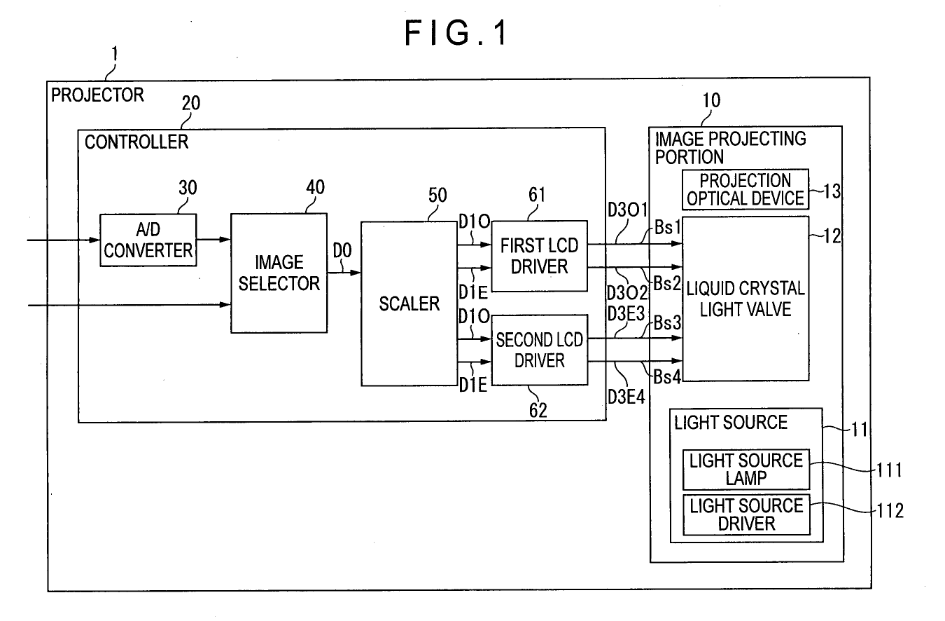

FIG. 1 is a block diagram showing an arrangement of a projector 1 (image display apparatus).

The projector 1 applies a predetermined image-processing on an input image information (image signal), forms an image light by optically processing a light beam irradiated by a light source based on the processed image information, and projects the image light onto a screen in an enlarged manner. As shown in FIG. 1, the projector 1 includes an image-projecting portion 10, a controller 20 and the like.

Under the control of the controller 20, the image projecting portion 10 forms an image light and projects the image light onto a screen in an enlarged manner. As shown in FIG. 1, the image projecting portion 10 has a light source 11, a liquid crystal light valve 12 (display device), a projection optical device 13 and the like.

The light source 11 irradiates the light beam onto the liquid crystal light valve 12 under the control of the controller 20. As shown in FIG. 1, the light source 11 includes a light source lamp 111 and a light source driver 112.

The light source lamp 111 is provided by an extra high-pressure mercury lamp. Incidentally, the light source lamp may not be an extra high-pressure mercury lamp but may alternatively be other discharge light-emitting source lamp such as metal halide lamp and xenon lamp. Further alternatively, various solid light-emitting elements such as light-emitting diode, laser diode, organic EL (electro luminescence) element and silicon light-emitting element may be used in place of a discharge light-emitting light source lamp.

The light source driver 112 drives the light source lamp 111 at a predetermined drive voltage under the control of the controller 20.

Though not specifically shown, the liquid crystal light valve 12 is provided by a general active-matrix liquid crystal panel. Specifically, the liquid crystal valve 12 includes a plurality of horizontally-extending scan lines, a plurality of vertically-extending data lines and a plurality of pixels arranged in matrix at intersections of the scan lines and the data lines. The matrix-arranged plurality of pixels (liquid crystal cells) are provided with switching elements such as TFT (Thin Film Transistor) elements of which gate is connected to the scan line and source is connected to the data line, and a pixel electrode connected to the drain of the switching element.

In the exemplary embodiment, the liquid crystal light valve 12 is provided in a format (1920×1080p) corresponding to full HDTV. The respective data lines are divided into units of four data lines.

Further, the liquid crystal light valve 12 is provided with a scan line driver, sampling circuit and data line driver and the like on an outside of an image formation area thereof.

The scan line driver is operated based on clock signals, transfer start pulses from the controller 20 and the like, which, for instance, sequentially shifts transfer start pulses that are fed at an initial stage of vertical scanning period in accordance with the clock signals and the like and outputs the transfer start pulses as scanning signals to the respective scan lines to sequentially select the respective scan lines.

The sampling circuit is provided with sampling switches for each data lines. The sampling circuit feeds below-described selected image signals respectively supplied through four signal-feeding lines Bs1-Bs4 to the divided four data lines (referred to as a “block” hereinafter) in response to sampling signal from the data line driver.

The data line driver is operated based on the clock signals and transfer start pulses and the like from the controller 20, which, for instance, sequentially shifts the transfer start pulse supplied at an initial stage of the horizontal scanning period in accordance with the clock signals and the like. The data line driver then narrows the pulse width of the shifted signal so that the pulse width of the adjoining signals are not superposed, and sequentially outputs the signal to each block as a sampling signal.

Below-described four selected image signals are sequentially written onto the respective image electrodes on the scan line selected by the scan line driver so as to change the alignment of liquid crystal molecule sealed within the liquid crystal cell, so that the liquid crystal light valve 12 transmits or blocks incident light beam for each of the pixels to form a predetermined image light.

The projection optical device 13 projects the image light irradiated by the liquid crystal light valve 12 onto a screen in an enlarged manner.

The controller 20 includes a CPU (Central Processing Unit), which controls the entire projector 1 in accordance with a control program stored in a memory. Incidentally, in order to simplify the description, only the function of the controller 20 for driving the liquid crystal light valve 12 will be described below to omit the other functions. Further, since the processing of the clock signal, the transfer start pulse and the like output to the liquid crystal light valve 12 is conventionally known, only the image-signal processing will be mentioned below as the function for driving the liquid crystal light valve 12.

As shown in FIG. 1, the controller 20 includes an A/D converter 30, an image selector 40, a scaler 50, a first and a second LCD drivers 61 and 62 (display drivers) and the like. Incidentally, though not specifically shown, the respective components 30-50, 61 and 62 are driven in accordance with the control signal from the CPU.

The image selector 40 selects and outputs one of a first image signal (analog image signal from an external image device being converted into a digital image signal by the A/D converter 30) and a second image signal (digital signal input from an external image device in accordance with, for instance, an HDMI (High-Definition Multimedia Interface) standard).

The second image signal is exemplified by various signal formats such as standard TV signal (480i) and HDTV (1080p, 720p) output from a television tuner and the like, and PC signal (SVGA, XGA, WXGA, SXGA and the like) output by a personal computer.

The scaler 50 converts the (digital) image signal selected by the image selector 40 into an image signal adapted for a display format (1080p) of the liquid crystal light valve 12 (i.e. an object to be driven).

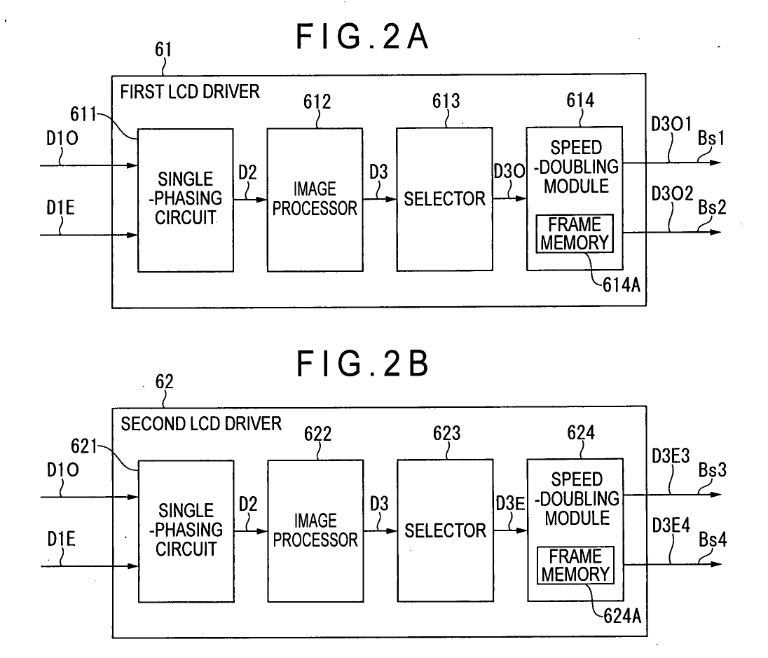

FIG. 2A and FIG. 2B are block diagrams showing an outline of the respective LCD drivers 61, 62.

The respective LCD drivers 61, 62 process the image signal output by the scaler 50 in a predetermined manner, and generate and output four selected image signals. The four selected image signals output by the respective LCD drivers 61, 62 are converted into an analog image signal by, for instance, a D/A converter and polarity inverter (both not shown) or the like, and subsequently are polarity-inverted (alternately reversing voltage level with respect to reference electric potential (i.e. amplitude center of electric potential of the image signal)) as necessary, which are supplied to the liquid crystal light valve 12 through the four signal feed lines Bs1-Bs4.

As shown in FIG. 2A, the first LCD driver 61 includes a single-phasing circuit 611, an image processor 612, a selector 613, a speed-doubling module 614 and the like. Incidentally, as shown in FIG. 2B, the second LCD driver 62 includes a single-phasing circuit 621, an image processor 622, a selector 623 and a speed-doubling module 624 (including a frame memory 624A), which are the same as those of the first LCD driver 61. Accordingly, only the arrangement of the first LCD driver 61 will be explained below and detailed description of the second LCD driver 62 will be omitted.

The single-phasing circuit 611 converts the image signal output by the scaler 50 into a single-phase signal in accordance with the control signal from the CPU.

The image processor 612 receives the single-phased image signal from the single-phasing circuit 611 and applies various image processing to the input image signal to output a processed image signal. The image processing can be exemplified by edge enhancement, black-and-white extension, color conversion, gamma correction, VT-gamma correction, shape correction and the like. Incidentally, the above various image processing are conventionally known, of which detailed explanation is not mentioned herein.

In accordance with the control signal from the CPU, the selector 613 selects, from the processed image signal output by the image processor 612, respective pixel data of a predetermined order on one scan line among all the pixels and outputs a selected image signal containing the selected respective pixel data.

The speed-doubling module 614 has a frame memory 614A (FIG. 2A) for temporarily storing the selected image signal output by the selector 613. The speed-doubling module 614 sequentially reads out two pixel data from the frame memory 614A at the same frequency as the frequency for writing the selected image signal on the frame memory 614A. Then, the speed-doubling module 614 supplies two selected image signals respectively containing the sequentially-read two pixel data to the liquid crystal light valve 12 (i.e. driving the liquid crystal valve 12 at a double speed) through the two signal feed lines Bs1 and Bs2. The speed-doubling module 614 reads out twice the same pixel data during one vertical scanning period (i.e. during a period until the pixel data written on the frame memory 614A is updated) from the frame memory 614A and supplies twice the same selected image signals to the liquid crystal light valve 12 through the signal feed lines Bs1 and Bs2.

The frame memory 614A has a memory capacity smaller than (specifically, half of) the memory capacity required for displaying a one screen image on the to-be-driven liquid crystal light valve 12 (display format: 1080p). More specifically, the frame memory 614A has a memory capacity that allows storing 960×1080 screen pixel data.

### Operation of Controller

Next, the operation of the above-described controller 20 will be described.

Initially, as shown in FIG. 1, the image selector 40 selects one of the first image signal output by the A/D converter 30 and the second image signal input by an external device, and output a selected image signal D0 to the scaler 50.

Next, the scaler 50 converts the input image signal D0 into an image signal adapted for a display format (1080p) of the to-be-driven liquid crystal valve 12 (e.g. dot clock: 150 MHz (frame frequency: 60 Hz)). As shown in FIG. 2A, the scaler 50 extends the converted image signal into two phases (serial-parallel conversion). Subsequently, the scaler 50 outputs: an image signal D1O (for instance, dot clock: 75 MHz) corresponding to respective pixels of odd number “1, 3, 5, 7, . . . ” on a particular scan line; and an image signal DIE (for instance, dot clock: 75 MHz) corresponding to respective pixels of even number “2, 4, 6, 8, . . . ” on the particular scan line respectively to the LCD drivers 61, 62.

The respective LCD drivers 61, 62 are simultaneously driven, however, for the convenience of explanation, the operations of the respective LCD drivers will be described in sequence.

Initially, the first LCD driver 61 is operated as follows.

Next, the image processor 612 applies various image processing to the input image signal D2 and outputs a processed image signal D3 (at the same frequency as the frequency of the image signal D2) to the selector 613.

As shown in FIG. 2A, the single-phasing circuit 611 converts the double-phased image signals D10, DIE input thereto into a single-phase signal to output an image signal D2 (double frequency of the image signals DIE, D10 (for instance, dot clock: 150 MHz)) containing respective pixel data of “1, 2, 3, 4, . . . ” corresponding to all the pixels to the image processor 612.

The selector 613 then selects the odd-numbered pixel data “1, 3, 5, 7, . . . ” on one scan line from the input processed image signal D3 and outputs a selected image signal D3O (at a half frequency of the frequency of the image signal D3 (for instance, dot clock: 75 MHz)) containing the pixel data “1, 3, 5, 7, . . . ” to the speed-doubling module 614.

Subsequently, the speed-doubling module 614 sequentially writes the input selected image signal D3O to the frame memory 614A at a half frequency of the processed image signal D3 (for instance, dot clock: 75 MHz). Further, the speed-doubling module 614 reads out from the frame memory 614A odd-ordered pixel data “1, 5, 9, 13, . . . ” assuming that the odd-numbered pixel data “1, 3, 5, 7, . . . ” on the particular scan line of the selected image signal D3O respectively correspond to first, second, third and fourth pixel data at the same frequency as the frequency of the selected image signal D3O (for instance, dot clock: 75 MHz) from the frame memory 614A. Then, a first selected image signal D3O1 containing the pixel data “1, 5, 9, 13, . . . ” is supplied to the liquid crystal light valve 12 through the signal feed line Bs1. Similarly, as shown in FIG. 2A, the speed-doubling module 614 sequentially reads out the pixel data of even-ordered pixel data “3, 7, 11, 15, . . . ” of the selected image signal D3O at the same frequency as the frequency of the selected image signal D3O from the frame memory 614A, so that a second selected image signal D3O2 containing the pixel data “93, 7, 11, 15, . . . ” is fed to the liquid crystal light valve 12.

On the other hand, the second LCD driver 62 is operated as follows.

Similarly to the first LCD driver 61, the single-phasing circuit 621 converts the double-phased image signals D1O, D1E input thereto into single-phased signals to output the image signal D2 to the image processor 622.

Next, the image processor 622 applies the same various image processing as the first LCD driver 61 to the input image signal D2 and outputs the processed image signal D3 to the selector 623 as shown in FIG. 2B.

Unlike the first LCD driver 61, as shown in FIG. 2B, the selector 623 then selects the even-numbered pixel data “2, 4, 6, 8, . . . ” on the particular scan line from the input processed image signal D3 and outputs a selected image signal D3E (at a half frequency of the frequency of the image signal D3 (for instance, dot clock: 75 MHz)) containing the pixel data “2, 4, 6, 8, . . . ” to the speed-doubling module 624.

Subsequently, the speed-doubling module 624 sequentially writes the input selected image signal D3E to the frame memory 624A at a half frequency of the processed image signal D3 (for instance, dot clock: 75 MHz). Further, the speed-doubling module 624 sequentially reads out from the frame memory 624A the odd-ordered pixel data “2, 6, 10, 14, . . . ” assuming that the pixel data “2, 4, 6, 8, . . . ” on the particular scan line of the selected image signal D3E respectively correspond to first, second, third and fourth pixel data at the same frequency as the frequency of the selected image signal D3E (for instance, dot clock: 75 MHz). Then, a third selected image signal D3E3 containing the pixel data “2, 6, 10, 14, . . . ” is supplied to the liquid crystal light valve 12 through the signal feed line Bs3. Similarly, as shown in FIG. 2B, the speed-doubling module 624 sequentially reads out the pixel data of even-ordered pixel data “4, 8, 12, 16, . . . ” of the selected image signal D3E at the same frequency as the frequency of the selected image signal D3E from the frame memory 624A, so that a fourth selected image signal D3E4 containing the pixel data “4, 8, 12, 16, . . . ” is fed to the liquid crystal light valve 12 through the signal feed line Bs4.

According to the above operations, when a sampling signal is output from the data line driver to the first block, pixel data “1” of the first selected image signal D3O1 containing the pixel data of “1, 5, 9, 13, . . . ”, pixel data “2” of the third selected image signal D3E3 containing the pixel data of “2, 6, 10, 14, . . . ”, pixel data “3” of the second selected image signal D3O2 containing the pixel data of “3, 7, 11, 15, . . . ”, and pixel data “4” of the fourth selected image signal D3E4 containing the pixel data of “4, 8, 12, 16, . . . ” are respectively written to the first, second, third and fourth pixels (pixel electrodes) of the scan line selected by the scan line driver.

Further, when the sampling signal is output from the data line driver to the next block, pixel data “5” of the first selected image signal D3O1, pixel data “6” of the third selected image signal D3E3, pixel data “7” of the second selected image signal D3O2, and pixel data “8” of the fourth selected image signal D3E4 are respectively written to the fifth, sixth, seventh and eighth pixels (pixel electrodes) of the scan line selected by the scan line driver.

In the same manner, data is repeatedly written on all of the blocks on the scan line in accordance with the sampling signals sequentially output from the data line driver to the respective blocks. Subsequently, the next scan line is sequentially selected by the scan line driver and the data is written in the same manner as the above, so that one-screen image (image light) is formed on the liquid crystal light valve 12.

Further, the speed-doubling modules 614, 624 respectively read out two pixel data from the frame memories 614A, 624A at the same frequency as the data-writing frequency to the frame memories 614A, 624A to feed the data to the liquid crystal light valve 12. Accordingly, the speed-doubling modules 614, 624 practically read out the pixel data from the frame memories 614A, 624A at a frequency twice as high as the data-writing frequency to the frame memories 614A, 624A (double-speed drive of the liquid crystal valve 12). Then, the speed-doubling modules 614, 624 read out the same pixel data twice from the frame memories 614A, 624A during one vertical scanning period (i.e. during the period until the pixel data written on the frame memories 614A, 624A are updated) and conduct the same data-writing as the above.

According to the above-described exemplary embodiment, following advantages can be obtained.

In the projector 1 of the exemplary embodiment, the liquid crystal light valve 12 is provided with two LCD drivers 61, 62 arranged in parallel. Further, the LCD drivers 61, 62 are respectively provided with the image processors 612, 622, the selectors 613, 623, and the speed-doubling modules 614, 624 respectively having the frame memories 614A, 624A. The memory capacity of the frame memories 614A, 624A is set so that 960×1080 screen pixel data, which is smaller than the 1920×1080 screen pixel data for full HDTV, can be stored therein. However, since 960×1080 screen pixel data (odd-numbered and even-numbered pixel data), i.e. half of the 1920×1080 screen pixel data for full HDTV, is selected by the selectors 613, 623 and is output as the selected image signals D3O, D3E, the 1920×1080 screen pixel data can be stored in the respective frame memories 614A, 624A. The two LCD drivers 61, 62 are driven to read out the pixel data at a frequency twice as high as the data-writing frequency to the frame memories 614A, 624A and to feed the data to the liquid crystal light valve 12. Accordingly, the same image can be written twice on the liquid crystal light valve 12 during one vertical-scanning period, thereby driving the liquid crystal light valve 12 of a display format corresponding to full HDTV.

Further, the image signal D2 corresponding to all the pixels of 1920×1080 screen pixel data is input to the image processors 612, 622 to apply the same image processing on the image signal D2. Accordingly, when edge enhancement that requires calculation of difference of pixel data (pixel value) between adjoining pixels and black-and-white extension that requires calculation of average value of the pixel data (pixel value) of all the pixels on one screen are to be applied, the image processors 612, 622 can efficiently apply the edge enhancement and black-and-white extension. Accordingly, the same image processing can be applied on the image written on the odd-numbered pixels (odd-numbered data lines) of the liquid crystal light valve 12 based on the selected image signals D3O1, D3O2 to which edge enhancement and black-and-white extension processing have been applied by the first LCD driver 61, and on the image written on the even-numbered pixels (even-numbered data lines) of the liquid crystal light valve 12 based on the selected image signals D3E3, D3E4 to which edge enhancement and black-and-white extension processing have been applied by the second LCD driver 62, thus exhibiting excellent display image without causing uncomfortable feeling.

Further, the frame memories 614A, 624A of the LCD drivers 61, 62 are provided with relatively small memory capacity (capacity that allows storing 960×1080 screen pixel data). Accordingly, even when two LCD drivers 61, 62 are used for driving the liquid crystal light valve 12 of the display format corresponding to full HDTV (1080p), production cost can be reduced as compared to a conventional arrangement where a single display driver provided with a frame memory with relatively large memory capacity (capacity that allows storing 1920×1080 screen pixel data).

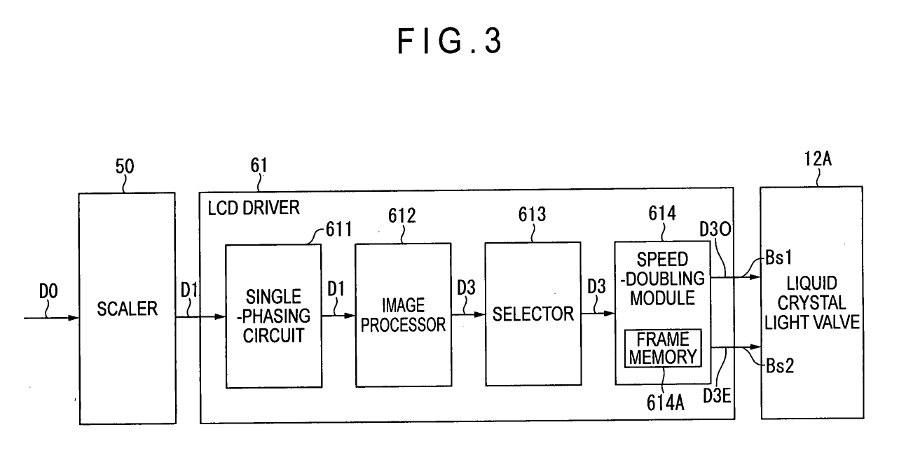

FIG. 3 is an illustration for explaining an effect of the exemplary embodiment.

In the above-described exemplary embodiment, the two LCD drivers 61, 62 are provided in parallel to drive the liquid crystal light valve 12 with a display format corresponding to full HDTV. Here, since the frame memories 614A, 624A are provided with memory capacity that allows storing 960×1080 screen pixel data, which is greater than 1280×720 screen pixel data corresponding to 720p, a liquid crystal light valve 12A adapted for a display format corresponding to 720p can be driven by operating the LCD driver 61 as follows with the use of one of the two LCD drivers 61, 62 (the LCD driver 61 in FIG. 3).

As shown in FIG. 3, the scaler 50 converts the input image signal D0 into an image signal D1 adapted for the display format (720p) of the to-be-driven liquid crystal light valve 12A and outputs the image signal D1 to the LCD driver 61.

As shown in FIG. 3, the single-phasing circuit 611 outputs the input image signal D1 directly to the image processor 612 in accordance with a control signal from the CPU.

Next, the image processor 612 applies the same various image processing as the above-described exemplary embodiment to the input image signal D1 and outputs the processed image signal D3 to the selector 613 as shown in FIG. 3.

Subsequently, as shown in FIG. 3, the selector 613 selects the pixel data corresponding to all the pixels from the processed image signal D3 in accordance with the control signal from the CPU and outputs the selected image signal D3 (identical with the processed image signal) to the speed-doubling module 614.

Then, the speed-doubling module 614 sequentially writes the input selected image signal D3 on the frame memory 614A. As shown in FIG. 3, the speed-doubling module 614 sequentially reads out from the frame memory 614A the respective odd-numbered data “1, 3, 5, 7, . . . ” from the pixel data “1, 2, 3, 4, . . . ” on a particular scan line of the selected image signal D3 at the same frequency as the frequency of the selected image signal D3 and feeds a first selected image signal D3O containing the respective pixel data “1, 3, 5, 7, . . . ” to the liquid crystal light valve 12A through the signal feed line Bs1. Similarly, as shown in FIG. 3, the speed-doubling module 614 sequentially reads out the pixel data of even-numbered pixel data “2, 4, 6, 8, . . . ” of the selected image signal D3 at the same frequency as the frequency of the selected image signal D3 from the frame memory 614A, so that a second selected image signal D3E containing the pixel data “2, 4, 6, 8, . . . ” is fed to the liquid crystal light valve 12.

According to the above-described operation of the LCD driver 61, the pixel data “1”, “2”, the pixel data “3”, “4”, the pixel data “5”, “6”, the pixel data “7”, “8” of the respective selected image signals D3O, D3E are sequentially written to the first, second, third, fourth, . . . pixels on the particular scan line of the liquid crystal light valve 12A.

Incidentally, unlike the liquid crystal light valve 12, the liquid crystal light valve 12A is divided into a block by a unit of two data lines.

Through the above operation of the LCD driver 61, the pixel data is read out at a frequency twice as high as the data-writing frequency to the frame memory 614A to be fed to the liquid crystal light valve 12A (driving the liquid crystal light valve 12A at a double speed), which allows the same images to be written twice on the liquid crystal light valve 12A in one vertical scanning period, thereby driving the liquid crystal light valve 12A adapted for 720p display format.

Accordingly, the LCD drivers 61, 62 can be used in common to the liquid crystal light valve 12 adapted to the display format corresponding to full HDTV (1080p) and the liquid crystal light valve 12A adapted to the display format corresponding to 720p.

The signal feed line connecting the LCD driver 61 and the liquid crystal valve 12 (12A) includes two signal feed lines Bs1, Bs2. After the selected image signal D3O (D3) is sequentially written onto the frame memory 614A, the two pixel data are sequentially read out at the same frequency as the data-writing frequency of the selected image signal D3O (D3) and the two selected image signals D3O1, D3O2 (D3O, D3E) are respectively fed to the liquid crystal light valve 12 (12A) through the two signal feed lines Bs1, Bs2, so that the pixel data is sequentially read out at a frequency twice as high as the data-writing frequency of the selected image signal D3O (D3), thereby driving the liquid crystal light valve 12 (12A) at a double-speed. The same applies to the LCD driver 62.

Further, since the LCD drivers 61, 62 include the single-phasing circuits 611, 612, it is not necessary to provide two image processors corresponding to two-phase image signals D1O, D1E but only a single image processor 612 (622) is required per one LCD driver, so that the circuitry of the LCD drivers 61, 62 can be simplified.

Incidentally, the scope of the present invention is not limited to the above-described exemplary embodiment, but includes modification and improvements as long as an object of the invention can be achieved.

Though the LCD driver 61 and the liquid crystal light valve 12 (12A) are connected by the two signal feed lines Bs1, Bs2, the LCD driver and the liquid crystal light valve may be connected with a single signal feed line or, alternatively, with more than two signal feed lines. The same applies to the LCD driver 62.

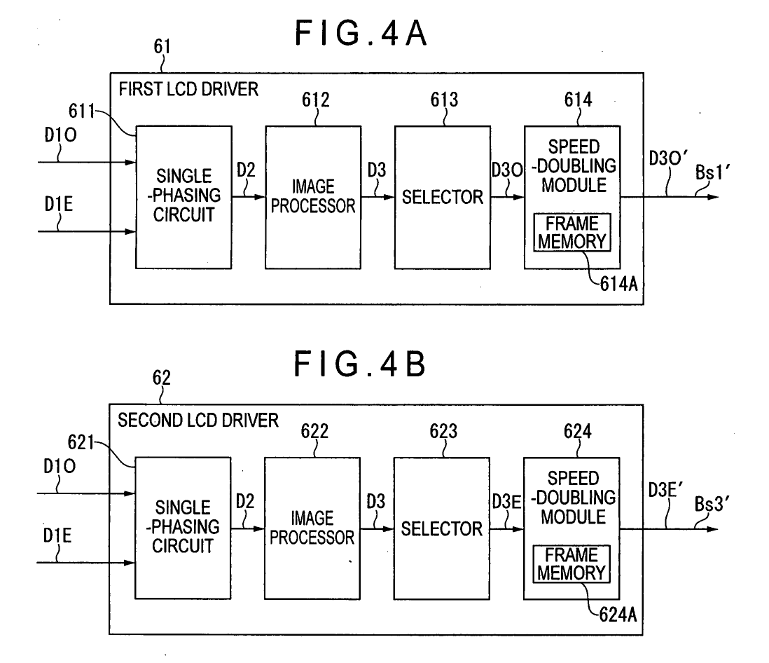

FIG. 4A and FIG. 4B are block diagrams showing a modification of the exemplary embodiment.

For instance, when the LCD driver 61 and the liquid crystal light valve 12 are connected with a single signal feed line Bs1′ and the LCD driver 62 and the liquid crystal light valve 12 are connected with a single signal feed line Bs3′, the speed-doubling modules 614, 624 are operated as follows.

After the selected image signals D3O, D3E are sequentially written onto the frame memories 614A, 624A, the speed-doubling modules 614, 624 sequentially reads out the pixel data at a frequency twice as high as the writing frequency of the selected image signals D3O, D3E. Then, the selected image signals D3O′, D3E′ containing the sequentially fetched pixel data are respectively fed to the liquid crystal light valve 12 through the signal feed lines Bs1′, Bs3′. According to the above arrangement, without providing two signal feed lines as in the above-described exemplary embodiment, data can be fed only by a single signal feed line Bs1′ (Bs3′), whereby the liquid crystal light valve 12 can be appropriately driven at a double speed. Incidentally, the same applies to a case where a single LCD driver 61 is used for the liquid crystal light valve 12A as shown in FIG. 3.

Though the speed-doubling module 614 (624) sequentially reads out the pixel data from the frame memory 614A (624A) at a frequency twice as high as the writing frequency of the selected image signal, the pixel data may alternatively be read out from the frame memories 614A (624A) at a frequency n-times (n being an integer of more than two) higher than the writing frequency of the selected image signal.

Though the respective odd-numbered (or even-numbered) pixel data on a particular scan line are selected from the processed image signal D3 in the above-described exemplary embodiment, the other pixel data may alternatively be selected.

Though the two LCD drivers 61, 62 are provided in parallel to the liquid crystal light valve 12, n (n being an integer more than two) LCD drivers may alternatively be provided in parallel to the liquid crystal light valve 12.

Though the same pixel data is read out twice from the frame memory 614A (624A) within one vertically-scanning period in the above-described exemplary embodiment, the input selected image signal may alternatively be directly fed to the liquid crystal light valve 12 while storing the selected image signal to the frame memory 614A (624A). After completely feeding the input selected signal directly to the liquid crystal light valve 12, the same pixel data may be read out from the frame memory 614A (624A) to be fed to the liquid crystal light valve 12 (thereby driving the liquid crystal light valve 12 at a double-speed). Incidentally, the same applies to a case where a single LCD driver 61 is used for the liquid crystal light valve 12A as shown in FIG. 3.

Though the two-phase image signals are respectively input to the LCD drivers 61, 62 in the above-described exemplary embodiment, single-phase image signals may alternatively be respectively fed. Further alternatively, more-than-two-phase image signal may be respectively input to the LCD drivers.

It is described in the above-described exemplary embodiment that the LCD drivers 61, 62 can be used in common to a liquid crystal light valve 12 formatted corresponding to full HDTV (1080p) and a liquid crystal light valve 12A formatted corresponding to 720p. However, the LCD drivers 61, 62 may alternatively be used in common to a liquid crystal light valve with the other display format.

Though the liquid crystal light valves 12, 12A are employed as an optical modulator in the above-described exemplary embodiment, the optical modulator may alternatively be a transmissive liquid crystal panel, a reflective liquid crystal panel, a DMD (Digital Micromirror Device) (trademark of Texas Instruments Inc, US).

Though a front-projecting projector 1 is used as an image display in the above-described exemplary embodiment, the present invention may be applied to various display devices such as an LCD device, organic EL (Electro luminescence) display device, plasma display device, CRT (Cathode-Ray Tube), and a rear projector.

Since the display driver according to the invention can be used in common to various display devices with different display formats, the display driver can be suitably used for image display apparatus used for presentation, home theater purpose and the like.

What is claimed is:

1. A display driver for driving a display device having a plurality of pixels, the display driver comprising:
an image processor that receives an image signal that contains information to be displayed on each of the plurality of pixels and applies a predetermined processing on the image signal to output a processed image signal;
a selector that selects the information corresponding to a predetermined pixel among the plurality of pixels to output a selected image signal; and
a memory that temporarily stores the selected image signal output by the selector, the selected image signal being read out from the memory to be fed to the predetermined pixel of the display device through a signal feed line.

2. The display driver according to claim 1, wherein
the signal feed line includes a plurality of signal feed lines, and
the selected image signal to be fed to different pixels of the display device is read out from the memory for each of the plurality of signal feed lines.

3. The display driver according to claim 1, wherein
the selected image signal to be fed to the pixels of the display device is read out from the memory through the signal feed line at a frequency equal to an integral multiple of the frequency of the selected image signal output by the selector.

4. The display driver according to claim 1, further comprising
a single-phasing circuit that, when the image signal input to the display driver is extended into a plurality of phases, converts the image signal of the plurality of phases into a single-phase signal to output to the image processor.

5. An image display apparatus, comprising:
a display device having a plurality of pixels; and
the display driver according to claim 1.

6. The image display apparatus according to claim 5, wherein
the display driver includes a plurality of display drivers arranged in parallel to the display device.

7. The image display apparatus according to claim 5, wherein
the display device is an optical modulator that modulates an incident light beam in accordance with the selected image signal fed by the display driver, and
the image display apparatus is a projector that comprises a light source that irradiates the light beam toward the optical modulator; and a projection optical device that projects the light beam modulated by the optical modulator in an enlarged manner.
